(19) United States
(12) Patent Application Publication
(10) Pub. No.: US 2011/0229787 A1
(43) Pub. Date: Sep. 22, 2011

(54) PROTON EXCHANGE MEMBRANE FUEL CELL STACK

(76) Inventors: Masaya KOZAKAI, Hitachinaka (JP); Tsutomu Okusawa, Hitachi (JP)

(21) Appl. No.: 13/034,876

(22) Filed: Feb. 25, 2011

(30) Foreign Application Priority Data
Mar. 17, 2010 (JP) 2010-060105

(51) Int. Cl. H01M 8/24; H01M 8/04

(52) U.S. Cl. 429/457

(57) ABSTRACT

A proton exchange membrane fuel cell stack comprises a plurality of stacked unit cells, the unit cells each including: a membrane electrode assembly; an anode side-conductive gas diffusion layer and an anode side-fuel gas flow field to feed a fuel gas to an anode of the membrane electrode assembly; and a cathode side-conductive gas diffusion layer and a cathode side-oxidant gas flow field to feed an oxidant gas to a cathode of the membrane electrode assembly; and a bipolar plate for separating between the anode side-fuel flow field and the cathode side-oxidant gas flow field. Then, the fuel gas flow field and the oxidant gas flow field are constituted by respective porous media flow fields each which is a conductive porous medium, and the porous media flow field for the oxidant gas flow field is configured so that liquid water is supplied mixedly together with the oxidant gas thereto.

### CLAIM OF PRIORITY

The present application claims priority from Japanese application serial no. 2010-060105 filed on Mar. 17, 2010, the contents of which are hereby incorporated by reference into this application.

### FIELD OF THE INVENTION

The present invention relates to a proton exchange membrane fuel cell stack for generating electrical energy through chemical reaction between hydrogen and oxygen.

### BACKGROUND ART

A proton exchange membrane fuel cell stack comprises a plurality of stacked unit cells each including a membrane electrode assembly (MEA). The MEA is comprised of a solid polymer electrolyte membrane, a fuel electrode catalyst layer (herein below will be also called as anode), and an oxidant electrode catalyst layer (herein below will be also called as cathode), wherein the anode and cathode are arranged on both sides of the solid polymer electrolyte membrane respectively. Both sides of the MEA are provided with gas diffusion layers consisted of a porous carbon material. Further both sides of the MEA having the gas diffusion layers are provided with bipolar plates for supplying a fuel gas and an oxidant gas respectively. The fuel cell stack with the above-mentioned arrangement is farther provided with clamping plates for clamping the both ends of the fuel cell stack.

The bipolar plate is generally provided with a channel for fuel gas or oxidant gas at one side thereof and a coolant flow channel at the other side face. The bipolar plate is produced, for example, by forming a plurality of ribs to be channels on the surfaces of a metal thin plate through a press working. In a case of a fuel cell stack having such bipolar plates, each top face (herein below will be also called as a rib) of the fuel gas channel at the anode side and each rib of the oxidant gas channel at the cathode side are contact in the respective gas diffusion layers.

At these contact portions, giving and receiving of electrons generated by electrochemical reaction is performed, and heat caused by the electrochemical reaction is transferred to coolant therethrough. Further, the fuel gas and the oxidant gas flow through the respective channels, and are supplied to the respective electrode catalyst via the respective gas diffusion layer.

For reasons such as that the efficiency of a fuel cell stack is higher than other power sources and environmental load thereof is low, the fuel cell stack is proceeding toward commercialization for stationary distributed power sources and for vehicle use power sources. In a case of the vehicle use power sources, for example, size and weight reduction thereof, in other words a high power density is required. For this requirement, it is necessary to perform a uniform power generation over the entire power generation face of fuel cell and to reduce parts that do not contribute to the power generation directly. A conventional bipolar plate for fuel cell has been formed by press working to thin metal plate thereby to form the reactant gas flow channel, roles of the bipolar plate with such a structure are shared in such a manner that current conduction of the bipolar plate is borne only by the ribs contacting the gas diffusion layer and the gas diffusion of the bipolar plate is borne only by the channel. Therefore, a distribution of the current conduction section and the gas diffusion section is resultantly caused depending on the sizes of such as the rib and the channel width. Although it is necessary for uniformalizing the power generation to finely divide the rib and the channel width, such fine division is limited from a viewpoint of press working capability.

In place of such conventional bipolar plate formed by press working, conceived is suggested about away of using a porous media in which fine pores communicate each other for the reactant gas flow field. Namely, in the case of using such porous member, it is possible to mix the porous medium's skeletal section serving as the current conducting section and fine pores for the gas diffusion portion and to uniformalize the mixture of them. Thereby, uniformalization of the power generation reaction can be achieved, and an increase of output power can be expected.

However, there is limit to enhance power density only by making the reactant gas flow channel porous. For further enhancement of the power density, it is necessary to design a high cooling density in a coolant flow channel that is a section other than the reactant gas flow channel, and to reduce the number of cooling section within a fuel cell stack stack-self. In particular, if the cooling section can be integrated with power generating section, the fuel cell stack can further be made in compact. For example, if cooling water is introduced at the same time together with the reactant gas into the reactant gas flow field, the cooling water is evaporated by the heat caused by the reaction and takes out latent heat of evaporation, thereby, a cooling effect can be obtained.

Patent document 1 (JP-A-2007-87805) discloses a method of introducing fine water drops into reactant gas through high pressure injection of water, as a method of supplying water into reactant gas.

### SUMMARY OF THE INVENTION

In the method of introducing fine water drops as disclosed in patent document 1, a fine water drop introducing mechanism is provided for every unit power generation cell, thus uniform cooling for the respective cells is expected. However, the fine water drop formation since requires injecting water in high pressure, it is difficult to downsize the fuel cell system because of an increase of such as auxiliary equipments and driving power.

The present invention is provided in view of these tasks, and an object of the present invention is to provide a fuel cell stack capable of downsizing the fuel cell stack by an easy and simple cooling structure.

First of all, the present invention has the following elements as a precondition. That is, a proton exchange membrane comprises a plurality of stacked unit cells, the unit cells each including: a membrane electrode assembly; an anode side-conductive gas diffusion layer and an anode side-fuel gas flow field to feed a fuel gas to an anode of the membrane electrode assembly; and a cathode side-conductive gas diffusion layer and a cathode side-oxidant gas flow field to feed an oxidant gas to a cathode of the membrane electrode assembly; and a bipolar plate for separating between the anode side-fuel flow field and the cathode side-oxidant gas flow field. Then, the fuel cell stack has the following features. Namely,

(1) The fuel gas flow field and the oxidant gas flow field are constituted by respective porous media flow fields each which is a conductive porous medium, and the porous media flow field for the oxidant gas flow field is configured so that liquid water is supplied mixedly together with the oxidant gas thereto.

In addition, the present invention may be the following features.

(2) The porous media flow field for the oxidant gas flow field may be provided with channels on a surface opposing to the bipolar plate, namely on the surface facing away from the membrane electrode assembly.
(3) The bipolar plate may be constituted by a porous plate having a permeability coefficient smaller than that of the media flow fields constituting the fuel gas flow field and the oxidant gas flow field.
(4) The porous plate may be hydrophilic.

According to the present invention, by the following arrangement where a reactant gas flow fields such as the fuel gas flow field and the oxidant gas flow field is constituted by the porous media as porous media flow fields, and where liquid water is supplied mixedly together with the oxidant gas into the porous media flow field, it is possible to perform cooling by means of latent heat of evaporation in the porous media field, and thereby to reduce the number of cooling cells and realize a thinning of the fuel cell stack. In detail, the porous media flow field's surface opposing to the membrane electrode assembly (MEA) can contact with almost surface of the cathode (electrode catalysts) through fine pores of the porous medium, the reaction can be effected over the almost entire faces of the electrode catalysts. Further, since the liquid water is caused mixed into the oxidant gas, and performs cooling by means of latent heat of evaporation, the number of cooling cells can be reduced, and a thinning of the fuel cell stack is enabled.

### BRIEF DESCRIPTION OF THE DRAWINGS

FIG. 1 is a partially sectional schematic drawing of a unit cell applied for a first embodiment of a fuel cell stack according to the present invention.

FIG. 2 is a partially sectional schematic drawing of a unit cell applied for a second embodiment of a fuel cell stack according to the present invention.

FIG. 3 is a schematic plane drawing showing a structure of a porous media flow field with a bipolar plate, applied for embodiments of the fuel cell stack according to the present invention, which is a schematic drawing created with reference to a plane provided with channels of the porous media flow field, and a broken line 20 therein shows a projection drawing of the bipolar plate containing manifolds for supplying and exhausting reactant gas.

FIG. 4 is an outline drawing of a constitution and a system of a stack structure in the fuel cell stack for embodiments of the present invention.

### EMBODIMENTS FOR CARRYING OUT THE INVENTION

Herein below, embodiments of the present invention will be explained with reference to the drawings in connection with a fuel cell stack according to the present invention.

### Embodiment 1

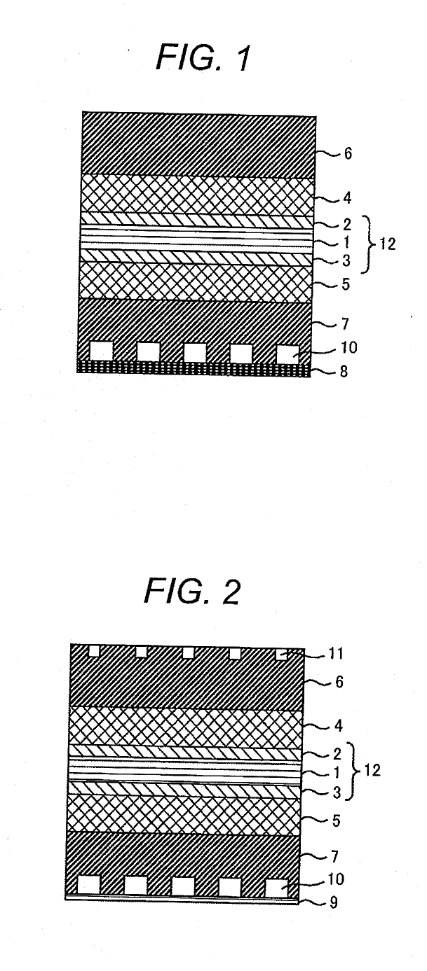

FIG. 1 is a sectioned schematic drawing of a unit cell applied for a first embodiment of a unit cell applied for a fuel cell stack according to the present invention, wherein the section drawing is illustrated along a direction perpendicular to a reactant gas flow direction in the fuel cell. The unit cell is comprised of: a membrane electrode assembly (MEA) 12 constituted by a solid polymer electrolyte membrane 1, an anode 2 as an electrode catalyst layer and a cathode 3 as an electrode catalyst layer, the anode 2 and cathode 3 being disposed on both sides of the solid polymer electrolyte membrane 1 respectively; gas diffusion layers 4 and 5, porous media flow fields 6 and 7 as an anode side-fuel flow field and a cathode side-oxidant gas flow field, and a porous bipolar plate 8 being disposed on the outsides of the electrode catalyst layers 2 and 3 respectively. The gas diffusion layers can be sometimes omitted. Further, although not illustrated, the unit cell is provided with a seal for preventing leakage of the reactant gas and cooling water.

The solid polymer electrolyte membrane 1 is consisted of a solid polymer material containing hydro carbon. The electrode catalyst layers 2 and 3 are made of carbon paste on which catalyst such as platinum is supported. The gas diffusion layers 4 and 5 are constituted by a carbon paper or carbon felt on which carbon fibers are bound therein. The membrane electrode assembly (MEA) 12 for the present embodiment uses one that can endure a fuel cell stack-operating temperature of more than 80° C., preferably more than 90° C. Herein below, the embodiment will be explained of for example using hydrogen as the fuel gas and air as the oxidant gas, however, hydrogen rich gas can be used as the fuel gas, and oxygen is most preferable as the oxidant gas.

The porous media flow fields 6 and 7 are constituted by a conductive porous media of a metallic material such as titanium, aluminum, magnesium, nickel, chromium, molybdenum or alloys such as SUS containing either of the listed materials as a part. The metallic porous medium is produced by e.g. foaming, sintering or binding of fine metallic fibers, and it uses the metallic material having porosity of more than 75% and containing pores having diameter more than 200 μm.

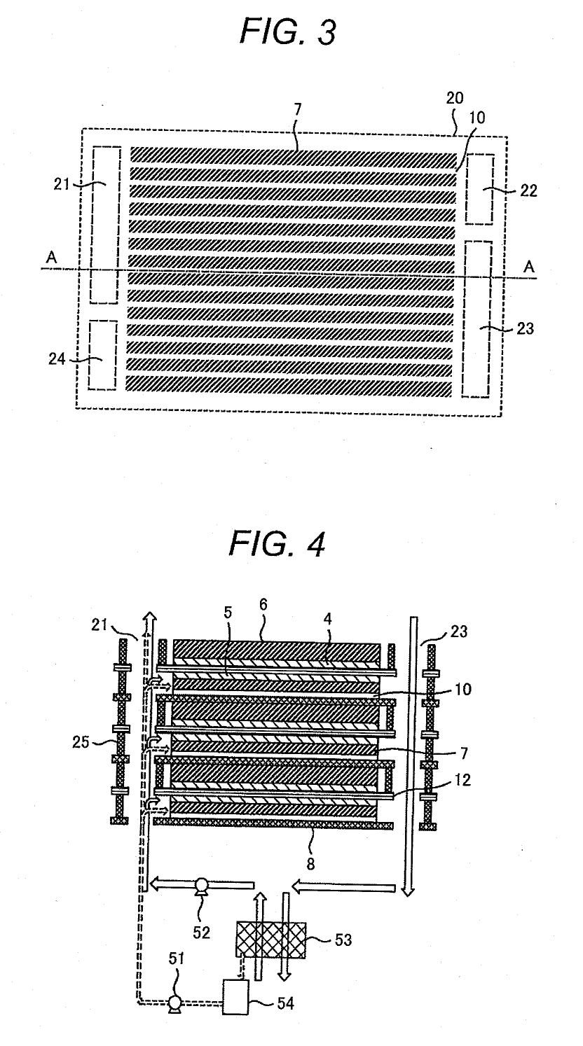

A plurality of cathode side-channels 10 is formed on the outside of the cathode side porous media flow field 7 facing the porous bipolar plate 8 by means of such as press work and cutting work. Although the cathode side channels 10 in FIG. 3 are formed in a straight shape in a gas flow direction, these shapes are not limited to the straight, they may have a shape including a curved line and a combination of straight and curved line. Liquid water supplied together with air serving as the reactant gas flows from an oxidant gas feeding manifold 21 shown by broken line in FIG. 3 to the cathode side-channels 10. A depth of each cathode side-channel 10 is preferable to be less than ½ of the cathode side porous media flow field 7 in order that the oxidant air is efficiently supplied to the cathode 3 through movement of the gas in the pores of the porous media flow field 7. Further, the total sum of the channels' sectional area is preferable less than ¼ of the sectional area of the cathode side-porous media flow field 7 with regard to the section shown in FIG. 1. In addition to the above-mentioned arrangement, the fuel cell may be provided with a straightening members (not illustrated) at inlet and outlet sides of the cathode side-channels 10, so that the liquid water supplied to the plurality of cathode side-channels 10 can be uniformly distributed over the surface of a power generation section. The amount of liquid water supplied is determined from the electrode area and the maximum operating current density, and it corresponds to the amount capable of cooling the fuel cell by latent heat of evaporation, with respect to the amount of heat generated during power generation.

The oxidant air mixed with the liquid water is introduced to the cathode side-porous media flow field 7. Heat is generated in the membrane electrode assembly (MEA) 12 by power generation, and is conducted to the cathode side-porous media flow field 7. In this situation, the liquid water supplied is evaporated by contacting with a skeleton of the metallic porous media constituting the cathode side-porous media flow field 7. Thereby, latent heat of evaporation is taken out from the porous media-skeleton at this moment, the cooling can be effected within the reactant gas. In the present invention, it is necessary to constitute the porous media flow field that permit enlarging its specific surface area in comparison with conventional channel structure. The evaporated water is exhausted together with the remaining reactant gas from a reactant gas exhaust manifold 23. Thereby, the temperature of the fuel cell stack can be maintained at a predetermined temperature without separately providing exclusive cooling cells, which is advantageous for downsizing the fuel cell stack.

In particular, when setting the fuel cell stack operating temperature at more than 90° C., the cooling since can be realized only by the cooling effect by means of the latent heat of evaporation, the amount of liquid water supplied through effusion into the reactant gas can be reduced significantly in comparison with a conventional fuel cell stack that utilizes sensible heat cooling by liquid water by making use of cooling cells.

The porous bipolar plate 8 is made of e.g. the same kind of metallic material as that of the porous media flow fields 6 and 7 or a material containing carbon as a main raw material, and the gas permeability coefficient thereof is set to be small in comparison with those of such as porous media flow fields 6 and 7 and the gas diffusion layers 4 and 5. By constituting the same in such a manner, the porous bipolar plate 8 can absorb a part of liquid water supplied to the plurality of cathode side-channels 10 in the cathode side porous media flow field 7 and liquid water produced by the electrochemical reaction, and the liquid water is held in the porous bipolar plate 8 through its capillary force. Thereby, the porous bipolar plate 8 becomes gas impermeable and is able to function to separate between hydrogen serving as the fuel gas on anode-side and air serving as the oxidant gas on cathode-side. Wettability of the porous bipolar plate 8 is preferably hydrophilic in a viewpoint that the plate 8 can hold water. The water held can be supplied to the anode through the anode side porous media flow field 6, which can prevent drying of the solid polymer electrolyte membrane 1 during the high current density operation.

When pressure losses between the two of in the anode side-porous media flow field 6 and in the cathode side-porous media flow field 7 are extremely different from each other, it may be feared that gas leakage from the high pressure side-field to the low pressure side-filed. When such operating condition is presumed, the gas permeability coefficient of the porous media of the porous media flow field showing a low pressure loss is set smaller than that of the porous media of the porous media flow field showing a high pressure loss, by combination of the porosity and the pore diameter. Further, the gas permeability coefficient can also be reduced by thinning a material thickness of the porous media flow field, thereby, it is possible to reduce a difference between pressure losses in the anode side porous media flow field 6 and in the cathode side porous media flow field 7 can be limited.

FIG. 4 is a longitudinal section drawing showing a part of a fuel cell stack as a fuel cell stack to which the present embodiment is applied. FIG. 4 shows the cross section drawing along a line A-A in FIG. 3 when stacking unit cells through each porous bipolar plate 8 as separators. The stack has each unit cell with an arrangement exampled as in FIG. 1, that is, the unit cell has the membrane electrode assembly (MEA) 12 in which the anode is disposed upward and a cathode is disposed downward while sandwiching the solid polymer electrolyte membrane therebetween.

Each element per unit of the fuel cell stack in FIG. 4 includes, in order from a top-side, the anode side-porous media flow field 6, the anode side-gas diffusion layer 4, the membrane electrode assembly (MEA) 12, the cathode side-gas diffusion layer 5, the porous media flow field 7, the bipolar plate 8, and subsequent another anode side-porous media flow field 6; and the fuel cell stack is configured by stacking the plurality of stack-elements repeatedly. Further, seals 25 provided in the fuel cell prevent the reactant gas from leaking outside and prevent the fuel gas and oxidant gas from mixing with each other around manifold 21. The electrode catalysts are coated on the power generating portion of the membrane electrode assembly (MEA) 12, but the electrode catalysts are not coated on the manifold peripheral portions and portions contacting to the seals 25.

A reactant gas feeding system to the fuel cell stack is constituted by an oxidant gas blower 52 for feeding oxidant air, a piping line connecting a liquid water injection pump 51 for supplying liquid water to the oxidant air, and the oxidant gas feeding manifold 21. Another piping line is provided for exhausting such as not reacted gas and steam from the oxidant gas exhaust manifold 23. Although a fuel system is not illustrated, Feeding of the fuel is performed by making use of pressure of a blower or a hydrogen bomb.

The oxidant air sent out from the oxidant gas blower 52 merges with the liquid water sent out from the liquid water injection pump 51 at midpoint of the piping, and is led into the oxidant gas feeding manifolds. The oxidant gas and the liquid water are supplied to the respective cells at the respective manifolds. The temperature within the respective cells can be kept constant by means of evaporation of the liquid water as explained in connection with FIG. 1. The exhaust gas is exhausted from the oxidant gas exhausting manifold 23 to the outside of the stack via the exhaust system piping.

Although it is possible to supply the liquid water from the outside, instead of that, it is also possible to supply the liquid water by condensing water in the exhaust gas via a heat exchanger 53, storing it in a condensed water collection tank 54 and reusing it from the tank 54. Thereby, the condensed water produced during the power generation reaction can be effectively used, and which can make a contribution to downsize the fuel cell stack.

According to the present embodiment, the arrangement of the fuel cell since is constituted by reactant gas flow field with a porous media and the gas flow field being in contact with the bipolar plate, the cathode side-porous media flow field's surface opposing the gas diffusion layer 5 (which is the one sandwiching the membrane electrode assembly (MEA) 12) can effectively contact over the gas diffusion layer 5 via the surface of the porous media as the porous media field-self. Thereby, the reactant gas can be supplied over the entire cathode side-surface of the electrode catalyst to make a uniform reaction over the entire cathode side-surface of the electrode catalyst substantially. Further, the liquid water since is mixed into the oxidant gas and the cooling is effected by means of latent heat of evaporation, the number of cooling cells can be reduced and a thinning of the fuel cell stack with stack structure can be realized.

### Embodiment 2

FIG. 2 is a sectioned schematic drawing of a second embodiment of a unit cell applied for a fuel cell stack according to the present invention, wherein the section drawing is illustrated along a direction perpendicular to a reactant gas flow direction in the fuel cell. In the second embodiment, almost the arrangement of the fuel cell is the same as that of the first embodiment according to the present invention and differences from the first embodiment are as follow. Namely, first of all, in addition to the cathode side-channels 10 in the cathode side-porous media field, the anode side-porous media flow field 6 (fuel gas flow field) is also provided with anode side-channels 11 on a surface opposing to a bipolar plate 9 of another unit cell stacked on the unit cell. Next, each bipolar plate 9 of the present embodiment's fuel cell stack is made of a metallic flat plate.

The bipolar plate 9 is constituted by a metallic plate such as a pure metal and an alloy each having thickness less than 0.2 mm or by a clad material formed by laminating and rolling plural these kind of metallic plates. For example, such as titanium, SUS, aluminum and magnesium are used for the material of the bipolar plate 9.

According to this embodiment, the bipolar plate 9 since is made of metallic flat plate, a part of the liquid water having been supplied to the cathode side-porous media field 7 or a part of the liquid water produced by the power generation reaction, can not be supplied to the anode side channels 11 through the bipolar plate 9. For this reason, in the present embodiment, the anode side-porous media flow field 6 is also provided with anode side-channels 11 on the surface opposing to the bipolar plate 9 so as to supply the liquid water to the anode side-channels 11 as with the cathode side-channels. Thereby, a part of the supplied liquid water in the anode-side channels is evaporated, which can be utilized keeping humidity of the anode. According to the above-mentioned purpose of the water supplied to the anode-side channels 11, the amount of the supplied water can be sufficiently small in comparison with that of the cathode side-channels 10 where secure cooling is required. For this reason, the sectional area per one channel of the anode side-channels 11 is set smaller than that of the cathode side channel groove 10 as shown in FIG. 2. For example, the width of the channel and the depth thereof are set smaller than those of the cathode side-channel 10. Furthermore, the total sectional area of the plurality of anode side-channels 11 is also set smaller than that of the cathode side-channels 10.

When constituting the unit cell by the above-mention arrangement of the second embodiment, the use of the bipolar plate 9 made of the metallic plate can ensure the gas impermeability. Further, by supplying the liquid water to the anode side-channels 11, it is possible to supplement a part of the water toward the cathode side together with protons, thereby to prevent the anode side from drying of the anode side in the solid polymer electrolyte membrane.

What is claimed is:

1. A proton exchange membrane fuel cell stack comprising a plurality of stacked unit cells, the unit cells each including: a membrane electrode assembly; an anode side-conductive gas diffusion layer and an anode side-fuel gas flow field to feed a fuel gas to an anode of the membrane electrode assembly; and a cathode side-conductive gas diffusion layer and a cathode side-oxidant gas flow field to feed an oxidant gas to a cathode of the membrane electrode assembly; and a bipolar plate for separating between the anode side-fuel flow field and the cathode side-oxidant gas flow field,
the fuel cell stack is characterized in that:
the fuel gas flow field and the oxidant gas flow field are constituted by respective porous media flow fields each which is a conductive porous medium, and
the porous media flow field for the oxidant gas flow field is configured so that liquid water is supplied mixedly together with the oxidant gas into the porous media flow field.

2. The proton exchange membrane fuel cell stack according to claim 1, wherein the porous media flow field for the oxidant gas flow field is provided with channels on a surface opposing to the bipolar plate.

3. The proton exchange membrane fuel cell stack according to claim 2,
wherein the bipolar plate is constituted by a porous plate having a permeability coefficient smaller than that of the media flow fields constituting the fuel gas flow field and the oxidant gas flow field.

4. The proton exchange membrane fuel cell stack according to claim 3, wherein the porous bipolar plate is hydrophilic.

5. The proton exchange membrane fuel cell stack according to claim 2, wherein the porous media for the fuel gas flow field is provided with channels on a surface opposing to the bipolar plate.

6. The proton exchange membrane fuel cell stack according to claim 5, wherein a sectional area of the anode side channels are smaller than those of the cathode side channels.

7. The proton exchange membrane fuel cell stack according to claim 5, wherein the bipolar plate is constituted by a metallic plate.
